(19) United States
(12) Patent Application Publication
(10) Pub. No.: US 2014/0188659 A1
(43) Pub. Date: Jul. 3, 2014

(54) United navigation method and its system

(71) Applicant: Hongjian Huang, Qidong (CN)

(72) Inventor: Hongjian Huang, Qidong (CN)

(21) Appl. No.: 14/215,630

(22) Filed: Mar. 17, 2014

(51) Int. Cl. G06F 21/31; G06Q 30/06

(52) U.S. Cl. CPC G06F 21/31; G06Q 30/0633
USPC 705/26.8; 726/7

(57) ABSTRACT

A united navigation method includes steps of: (1) receiving login information of an account from a client terminal by a main server; (2) verifying whether the login information is right or not by the main server; if no, going to (3); if yes, going to (4); (3) sending a notification of wrong login information into the client terminal by the main server; (4) recording activities of the account which has logged into the main server by the main server; and (5) sending the login information by the main server into designated secondary servers, in such a manner that the account logs into the designated secondary servers. The united navigation method, after the step (4) or the step (5), further includes a step of: (6) receiving a payment request from the client terminal and responding to the payment request by the main server. A united navigation system is also provided.

### BACKGROUND OF THE PRESENT INVENTION

1. Field of Invention

The present invention relates to a website navigation technology, and more particularly to a united navigation method and its system.

2. Description of Related Arts

Throughout the numerous different domain names of different websites, the navigation website provides users a quick and short path to pick out the desired website. In the meantime, the navigation website also informs the users of many available choices by presenting different links at one web page. By clicking on the link, the users enter the desired website and are asked to submit the login information for logging in. Thus clicking on different links means that the users are asked to submit respective login information each time.

However, some websites begin to share one account system, which means the user is able to log in different websites by submitting identical login information. Despite of the simplicity, the user is required to manually link the login information of a first website with a second website before the two websites share the login information. Moreover, the account of the first website and the account of the second website still remain to be independent with each other and keep respective records of activities of the user. For example, the user is unable to buy songs at iTunes Store with the available gift card balance of the account on Amazon.cn, although the available gift card balance of the account belongs to of the user.

Thus, in order to overcome the above disadvantages, it is necessary to provide a united navigation method and its system which unites the accounts on the different websites and allows the user to log in different websites by inputting the login information only once.

### SUMMARY OF THE PRESENT INVENTION

An object of the present invention is to provide a united navigation method which provides a plurality of websites and allows users to log in the plurality of websites by inputting login information only once.

Another object of the present invention is to provide a united navigation system which has an account system which records activities of respective accounts on the plurality of websites.

Yet another object of the present invention is to provide a united navigation system which unites payment on the plurality of websites.

Yet another object of the present invention is to provide a united navigation method through which the plurality of websites shares available balance together.

Accordingly, in order to accomplish the above objects, the present invention provides a united navigation method which comprises steps of:

(1) receiving login information of an account from a client terminal by a main server;

(2) verifying whether the login information is right or not by the main server; if no, going to (3); if yes, going to (4);

(3) sending a notification of wrong login information into the client terminal by the main server;

(4) recording activities of the account which has logged into the main server by the main server;

(5) sending the login information by the main server into designated secondary servers, in such a manner that the account logs into the designated secondary servers; or

(6) receiving a payment request from the client terminal and responding to the payment request by the main server.

Further, the step (5) comprises steps of:

(5a) receiving a visit request from the client terminal by the main server; and

(5b) sending the login information into secondary servers which are designated by the visit request, in such a manner that the account logs into the secondary servers, and receiving feedbacks from the visited secondary servers, by the main server.

The present invention further provides a united navigation system which comprises a client terminal, a main server having an account system and a plurality of secondary servers, wherein the client terminal is connected to the main server; the main server has links to the plurality of secondary servers simultaneously.

The client terminal is for receiving login information about an account from a user and sending the login information into the main server. The main server is for receiving the login information and verifying the login information of the account with the account system. When the main server verifies that the login information is right, the main server records that the account is logging into the main server.

Then, the client terminal is also for sending a visit request into the main server; the main server is for receiving the visit request and sending the login information to the secondary servers which are correspondent to the visit request.

Preferably, when the main server verifies that the login information is right, the main server automatically sends the login information to all the secondary servers, in such a manner that the account logs in all the secondary servers. As a result, whichever secondary server the user requests to visit, the main server automatically links to the secondary server the user requests to visit, without asking the user to submit the login information again.

Then, the client terminal is also for sending a payment request into the main server; the main server is for receiving the payment request and responding to the payment request.

Preferably, the main server directly executes payment. Also preferably, the main server transfers the payment request to the secondary server and receives a feedback of a payment result after the secondary server executes and finishes the payment request.

These and other objectives, features, and advantages of the present invention will become apparent from the following detailed description, the accompanying drawings, and the appended claims.

### BRIEF DESCRIPTION OF THE DRAWINGS

FIG. 1 is a block diagram of a united navigation system according to a first preferred embodiment of the present invention.

FIG. 2 is a sketch view of a client terminal of the united navigation system according to the first preferred embodiment of the present invention.

FIG. 3 is a first alternative mode of a secondary server of the united navigation system according to the first preferred embodiment of the present invention.

FIG. 4 is a second alternative mode of the secondary server the united navigation system according to the first preferred embodiment of the present invention.

FIG. 5 is an alternative mode of a main server of the united navigation system according to the first preferred embodiment of the present invention.

FIG. 6 is a block diagram of the united navigation system according to a second preferred embodiment of the present invention.

### DETAILED DESCRIPTION OF THE PREFERRED EMBODIMENT

Referring to FIG. 1 of the drawings, according to a first preferred embodiment of the present invention, a united navigation system comprises a client terminal, a main server connected to the client terminal, and a secondary server linked to the main server. The main server receives login information of an account from the client terminal, and verifies whether the login information. If the login information is verified to be right, the main server records that the account is logging in and starts to record activities of the account.

The main server has an account system and verifies the login information of the account with the account system. If the login information is verified to be wrong, the main server sends a notification of wrong login information into the client terminal; the client terminal can receive corrected login information for verifying by the main server again. The account comprises passwords, a nickname, a security code, personal web zone, mailbox, personal e-wallet and even personal real name.

If a user intends to browse web pages and visit the secondary server, the main server receives a visit request from the client terminal, wherein the visit request designates the secondary server. For responding to the visit request, the main server sends the login information into secondary server which is designated by the visit request, in such a manner that the account logs into the secondary server; and then the main server starts to receive feedbacks from the visited secondary server.

Referring to FIG. 1 of the drawing, according to the first preferred embodiment of the present invention, the secondary servers comprise a first secondary server linked to the main server, and a second secondary server linked to the main server.

When the visit request designates the first secondary server and the main server records that the account is logging into the main server, the main server sends the login information into the first secondary server, in such a manner that the account logs into the first secondary server; and then the main server receives feedbacks about the activities of the account from the first secondary server to update the record of the activities of the account. Sending the login information into the designated secondary server according to the visit request from the client terminal is an economic manner which relieves the main server from big workload.

Preferably, after the main server records that the account is logging in and starts to record activities of the account, the main server automatically sends the login information to all of the secondary servers, without any visit request initiated at the client terminal, in such a manner that the account automatically logs into all of the secondary servers once the account logs into the main server. It is a great burden upon the main server to automatically send the login information to all of the secondary servers, but also a great convenience for the user.

When the visit request designated the second secondary server and the main server records that the account is logging into the first secondary server, the main server sends the login information into the second secondary server, in such a manner that the account logs into the second secondary server; and then the main server receives feedbacks about the activities of the account from the second secondary server to update the record of the activities of the account.

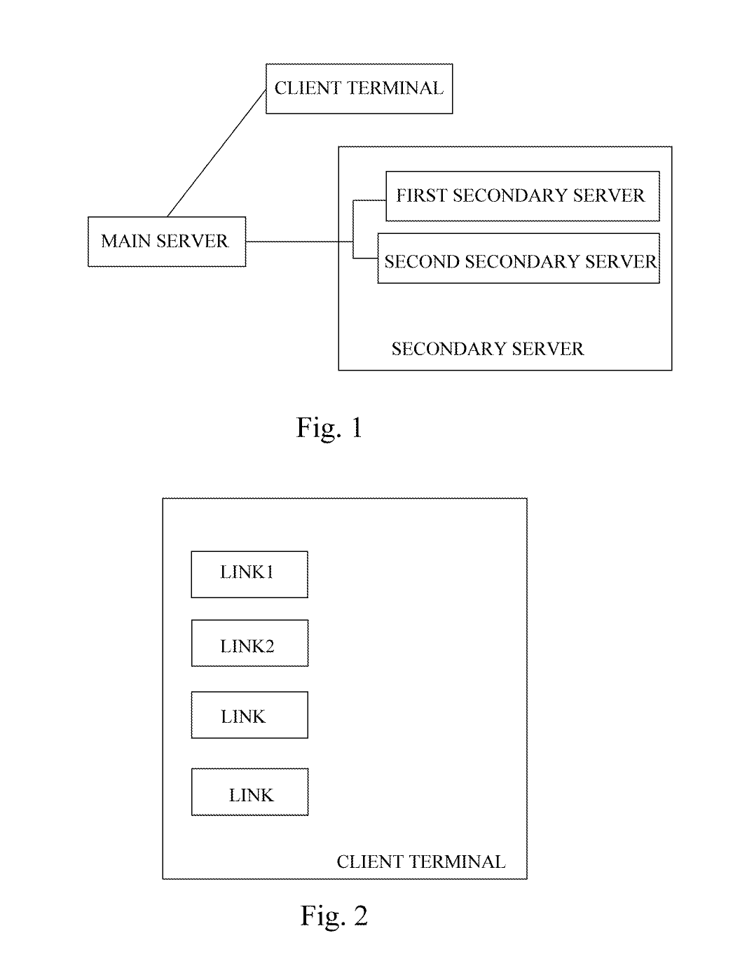

Referring to FIG. 2, according to the first preferred embodiment of the present invention, the client terminal displays a plurality of links for initiating the visit request, wherein the link1 corresponds to the first secondary server; the link2 corresponds to the second secondary server. By clicking on the link1, the client terminal sends the visit request designating the first secondary server into the main server; the main server receives the visit request designating the first secondary server, sends the login information into the first secondary server and records that the account is logging into the first secondary server, in such a manner that the visit request designated the first secondary server is executed and accomplished.

Obviously, the links are usually embodied as different website links presented on a web page showed on the client terminal, such as a mobile phone and a computer. The two secondary servers and the correspondent two links are only exemplary. One skilled in the art understands that the secondary servers are not limited to two and that accordingly the links are not limited to two.

Further referring to FIG. 1, according to the first preferred embodiment of the present invention, if a user intends to pay, the main server receives a payment request from the client terminal.

When the main server records that the account is logging into the main server, the main server directly executes payment. The main server can be responsible for social insurance charge, telecommunication charge, tax payment and refund, and municipal services.

When the main server records that the account is logging into the first secondary server, the main server directly executes payment, and sends a payment result into the first secondary server; the first secondary server receives the payment result and then the payment request is executed and accomplished.

Or, when the main server records that the account is logging into the first secondary server, the first secondary server executes payment and sends a payment process or a payment result as feedbacks into the main server; the main server receives the feedbacks from the first secondary server and then the payment request is executed and accomplished.

When the main server records that the account is logging into the second secondary server, the main server directly executes payment, and sends a payment result into the second secondary server; the second secondary server receives the payment result and then the payment request is executed and accomplished.

In the meantime, the main server records the execution of payment, and accordingly updates the record of the activities of the account.

Preferably, when the main server records that the account is logging into the first secondary server, the first secondary server executes payment and sends a payment process as feedbacks into the main server in real time, in such a manner that the main server updates the record of the activities of the account in real time, which indicates currently available balance and help the user avoid overdraft during multiple payments are being executed.

Preferably, when the main server records that the account is logging into the first secondary server, the first secondary server executes payment and sends a payment result as feedbacks into the main server in real time, in such a manner that the secondary server shares a part of computing load and the main server is relieved to some extent.

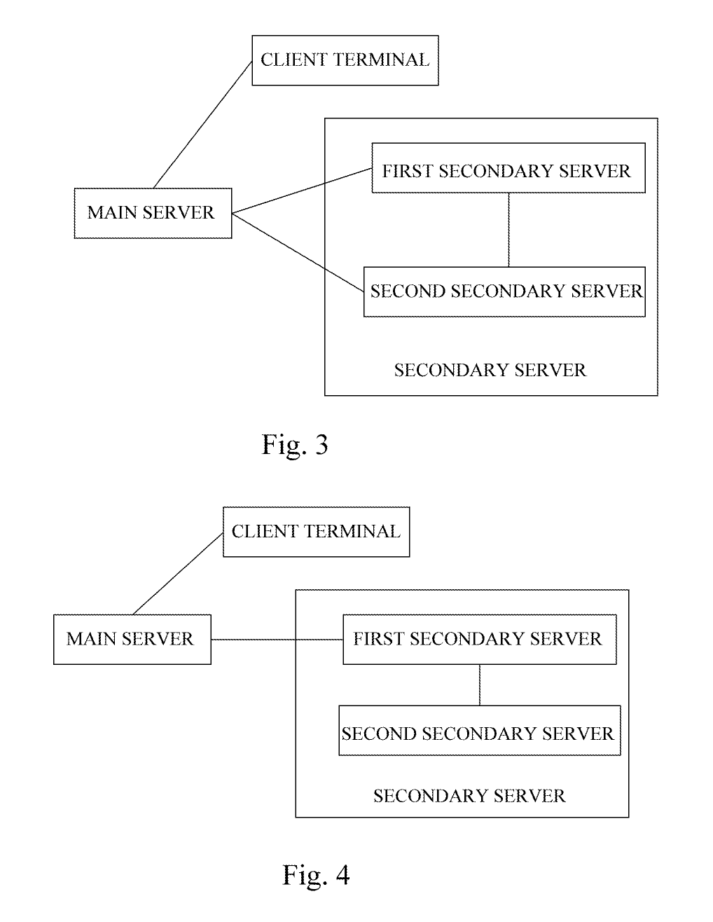

Referring to FIG. 3 of the drawings, a first alternative mode of the secondary server comprises a first secondary server linked to the main server, and a second secondary server linked to the main server and the first secondary server.

When the main server receives a visit request which designates the second secondary server and the main server records that the account is logging into the first secondary server, the first secondary server sends the login information into the second secondary server, in such a manner that the account logs into the second secondary server; and the main server receives feedbacks about the activities of the account from the second secondary server to update the record of the activities of the account.

Further, when the main server receives a payment request and records that the account is logging into the second secondary server, the first secondary server executes payment, sends feedbacks of a payment process and a payment result into the main server; and then the main server sends the payment result into the second secondary server, in such a manner that the first secondary server and the second secondary server share available balances together.

Referring to FIG. 4 of the drawings, a second alternative mode of the secondary server comprises a first secondary server linked to the main server, and a second secondary server linked to the first secondary server.

When the main server receives a visit request which designates the second secondary server and the main server records that the account is logging into the first secondary server, the first secondary server sends the login information into the second secondary server, in such a manner that the account logs into the second secondary server; the first secondary server receives feedbacks about the activities of the account from the second secondary server; and the main server receives the feedbacks from the first secondary server.

Further, when the main server receives a payment request and records that the account is logging into the second secondary server, executing payment by the first secondary server, sending a payment result into the second secondary server by the first secondary server, and receiving feedbacks of the payment result and a payment process from the first secondary server by the main server.

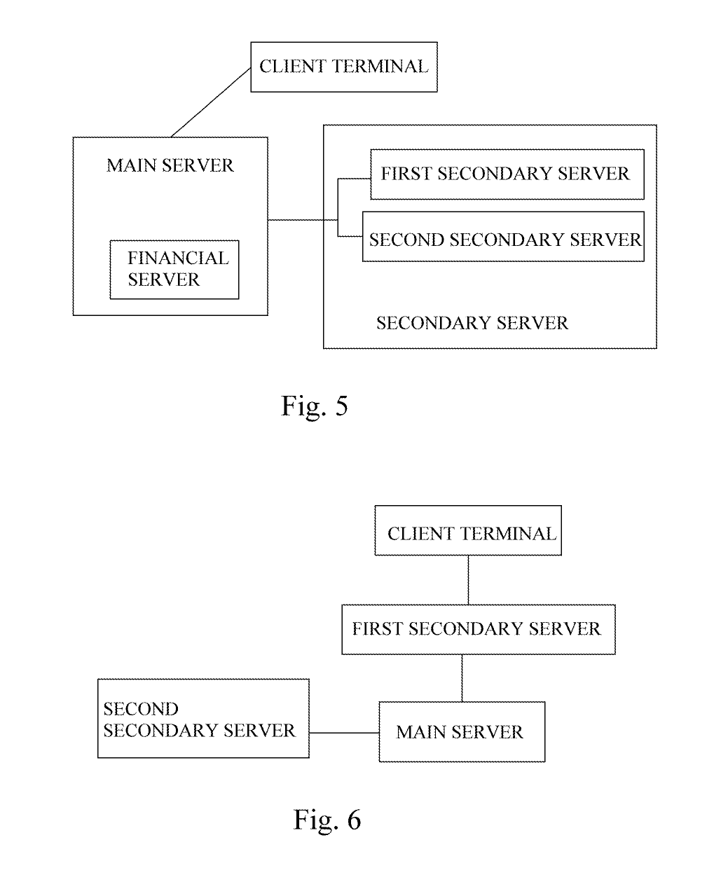

Referring to FIG. 5, preferably the main server comprises a financial server which is linked to the secondary server and in charge of financial transactions of the account system, comprising payment.

According to the first preferred information, the account belongs to the account system on the main server; the user logs into the main server and then the secondary servers which are within the links of the main server via the account. For the account beyond the account system on the main server, the user logs into the main server as follows.

Referring to FIG. 6 of the drawings, according to a second preferred embodiment of the present invention, a united navigation system comprises a client terminal, a first secondary server connected to the client terminal, a main server linked to the first secondary server, and a second secondary server linked to the main server, wherein the first secondary server has a secondary account system; and the main server has a main account system. An account belongs to the secondary account system and the user intends to log into the main server via the account.

When the user input login information about the account via the client terminal, the first secondary server receives the login information and verifies the login information with the secondary account system. When the login information is verified to be right, the account logs into the first secondary server; and the first secondary server starts to record the activities of the account. Because the first secondary server is linked to the main server, when the client terminal sends a visit request designating the main server into the first secondary server, the first secondary server sends the login information into the main server which is designated by the visit request, and the main server adds the login information of the account into the main account system, in such a manner that the account logs into the main server and belongs to the main account system.

Preferably, before the first secondary server sends the login information into the main server, the first secondary server sends a notification whether the user agrees to link the main server into the client terminal; if the client terminal receives a positive answer, the first secondary server sends the login information into the main server, otherwise not.

For example, the main server of the united navigation system has links respectively to a first secondary server which belongs to Amazon.cn and a second secondary server which belongs to iTunes Store; correspondently, the client terminal presents a web page containing a first link indicating Amazon.cn and a second link indicating iTunes Store in front of the user. For the user who has already registered on the main server and obtained an account within the account system, the user logs in the web page after submitting the right login information; in other words, the user logs into the main server via the account. By clicking on the first link, the main server sends the login information into the first secondary server which belongs to Amazon.cn, in such a manner that the account logs into Amazon.cn after submitting the login information only once. For the user who has only registered on the Amazon.cn and obtained an account within the secondary account system, the user logs into Amazon.cn after submitting the right login information, which means the user logs into the first secondary server via the account. A link showed on Amazon.cn goes to the web page containing the first link and the second link and the link indicates that the first secondary server is linked to the main server. By clicking on the link showed on Amazon.cn, the first secondary server sends the login information into the main server; the main server adds the login information into the account system and the account logs into the main server. In other words, the main account system and the secondary account system shares the account.

One skilled in the art will understand that the embodiment of the present invention as shown in the drawings and described above is exemplary only and not intended to be limiting.

It will thus be seen that the objects of the present invention have been fully and effectively accomplished. Its embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A united navigation method, comprising steps of:
(1) receiving login information of an account from a client terminal by a main server;
(2) verifying whether the login information is right or not by the main server; if no, going to (3); if yes, going to (4);
(3) sending a notification of wrong login information into the client terminal by the main server;
(4) recording activities of the account which has logged into the main server by the main server; and
(5) sending the login information by the main server into designated secondary servers, in such a manner that the account logs into the designated secondary servers.

2. The united navigation method, as recited in claim 1, after the step (4) or after the step (5), further comprising a step of:
(6) receiving a payment request from the client terminal and responding to the payment request by the main server.

3. The united navigation method, as recited in claim 2, wherein the step (5) comprises steps of:
(5a) receiving a visit request from the client terminal by the main server; and
(5b) sending the login information into secondary servers which are designated by the visit request, in such a manner that the account logs into the secondary servers, and receiving feedbacks from the visited secondary servers, by the main server.

4. The united navigation method, as recited in claim 2, wherein the step (5) comprises: sending the login information by the main server into all secondary servers, in such a manner that the account logs into all the secondary servers.

5. The united navigation method, as recited in claim 3, wherein the step (5b) comprises: when the visit request designates a first secondary server and the main server records that the account is logging into the main server, sending the login information by the main server into the first secondary server, in such a manner that the account logs into the first secondary server, and receiving feedbacks about the activities of the account by the main server from the first secondary server to update the record of the activities of the account.

6. The united navigation method, as recited in claim 5, wherein the step (5b) further comprises: when the visit request designates a second secondary server and the main server records that the account is logging into the first secondary server, sending the login information by the main server into the second secondary server, in such a manner that the account logs into the second secondary server, and receiving feedbacks about the activities of the account by the main server from the second secondary server to update the record of the activities of the account.

7. The united navigation method, as recited in claim 5, wherein the step (5b) further comprises: when the visit request designates a second secondary server and the main server records that the account is logging into the first secondary server, sending the login information into the second secondary server by the first secondary sever, in such a manner that the account logs into the second secondary server; and then receiving feedbacks about the activities of the account by the main server from the second secondary server to update the record of the activities of the account.

8. The united navigation method, as recited in claim 5, wherein the step (5b) further comprises: when the visit request designates a second secondary server and the main server records that the account is logging into the first secondary server, sending the login information into the second secondary server by the first secondary sever, in such a manner that the account logs into the second secondary server, and receiving feedbacks about the activities of the account by the first secondary server from the second secondary server; then receiving the feedbacks about the activities of the account by the main server from the first secondary server to update the record of the activities of the account.

9. The united navigation method, as recited in claim 2, wherein the step (6) comprises: when the main server records that the account is logging into the main server, directly executing payment by the main server.

10. The united navigation method, as recited in claim 5, wherein the step (6) comprises: when the main server records that the account is logging into the first secondary server, directly executing payment by the main server, and sending a payment result into the first secondary server by the main server.

11. The united navigation method, as recited in claim 5, wherein the step (6) comprises: when the main server records that the account is logging into the first secondary server, executing payment by the first secondary server, and receiving feedbacks of a payment process or a payment result from the first secondary server by the main server.

12. The united navigation method, as recited in claim 6, wherein the step (6) comprises: when the main server records that the account is logging into the second secondary server, directly executing payment by the main server, and sending a payment result into the second secondary server by the main server.

13. The united navigation method, as recited in claim 7, wherein the step (6) comprises: when the main server records that the account is logging into the second secondary server, executing payment by the first secondary server, receiving feedbacks of a payment process and a payment result from the first secondary server by the main server, and sending the payment result into the second secondary server by the main server.

14. The united navigation method, as recited in claim 8, wherein the step (6) comprises: when the main server records that the account is logging into the second secondary server, executing payment by the first secondary server, sending a payment result into the second secondary server by the first secondary server, and receiving feedbacks of the payment result and a payment process from the first secondary server by the main server.

15. A united navigation system, comprising a client terminal, a main server having an account system and a plurality of secondary servers, wherein said client terminal is connected to said main server; said main server has links to said plurality of secondary servers simultaneously;
wherein said client terminal is for receiving login information about an account from a user and sending said login information into said main server, wherein said account system has said account and further said login information; said main server is for receiving said login information and verifying said login information of said account with said account system; when said main server verifies that said login information is right, said account logs into said main server; when said main server verifies that said login information is wrong, said main server sends a notification of wrong login information into said client terminal;
wherein said client terminal is further for sending a request into said main server; said main server is for receiving said request and responding to said request; said request comprises a visit request designating said secondary servers and a payment request; said main server responds to said visit request by sending said login information to said designated secondary servers which are correspondent to said visit request, without receiving said login information from said client terminal again; said main server responds to said payment request by directly executing payment; or said main server responds to said payment request by transferring said payment request to one of said secondary servers and receives a feedback of a payment result after said one secondary server executes said payment request.
